(19) United States
(12) Patent Application Publication
(10) Pub. No.: US 2009/0150790 A1
(43) Pub. Date: Jun. 11, 2009

(54) NAVIGATION GRAPH WITH STRATEGIC INFORMATION

(76) Inventor: Markus Wilhelm, Sulzbach/Saar (DE)

Correspondence Address: Maryam Imam, 95 SOUTH MARKET STREET, SUITE 570, SAN JOSE, CA, 95113, US

(21) Appl. No.: 11/996,871

(22) PCT Filed: Jul. 28, 2006
(86) PCT No.: PCT/EP2006/007522

§ 371 Date: Jul. 18, 2008

(30) Foreign Application Priority Data
Jul. 28, 2005 (DE) 102005035908.6

(51) Int. Cl. G06F 3/048

(52) U.S. Cl. 715/737

(57) ABSTRACT

A navigation graph represents part of a virtual environment in which a computer-controlled agent can move. The navigation graph has nodes and edges. In the case of the navigation graph presented here, the nodes are supplemented with strategic information. An agent can use this information to carry out tactical calculations in order to determine positions for ambushes or marksmen. The strategic information is based on details of the visibility of the node with respect to other nodes and neighborhood relationships with adjacent nodes. The visibility of a node will be calculated with the aid of depth information which is calculated and provided by a graphics card.

### FIELD OF THE INVENTION

The invention involves robot control, simulations or computer games. Increasingly, “agents” are used here. Agents are software modules which generally correspond to an independent artificial subject or player. In the case of car racing, for example, the human player will drive a car, while the other cars are agents, or controlled by agents. An agent could, however, also take control of a robot in the real world.

There are various aspects if an agent with artificial intelligence is intended to interact with a virtual environment. Probably the most important area, which has also been examined the longest, is the navigation of the agent inside such a world.

Regarding the navigation of an agent in a virtual world, frequently the question arises how he gets from point A to point B.

### PRIOR ART

The known A-star algorithm exists as a solution to this question. It supplies a sequence of points which the agent must head for in order to arrive at his destination. This could be compared in the real world to someone who reads a map and gathers therefrom piece-by-piece the path to the destination. The path ascertained can, however, only be as good as the map.

If the aspect of the map is transferred to the virtual world, two frequently used data structures for the representation of paths are arrived at. These are, firstly, waypoints which mark positions inside the virtual world and can be traversed. Waypoints are interconnected by virtue of edges, so that it can be determined from which position another position can be reached. A navigation graph offers another method of generating a map of the virtual world.

A navigation graph is a graph Gₙₐᵥ which contains information which can be used, for example, by an agent. It is used for abstracting the virtual world to the extent that an agent can perform a path calculation in order to get from point A to point B. In a navigation graph, known algorithms, such as the A-star algorithm, can perform a path calculation.

### OBJECT

It is an object of the invention to improve the navigation and orientation of agents in virtual worlds.

### SOLUTION

Said object is achieved by the inventions with the features of the independent claims. Advantageous developments of the inventions are characterized in the subclaims. The wording of all the claims is hereby incorporated in this description by reference. The invention also encompasses all combinations of independent and/or dependent claims which are sensible and in particular those which are mentioned.

Individual method steps are described in more detail below. The steps need not necessarily be performed in the order stated, and the method described can also have other steps which are not mentioned.

If the aim is to have an agent which can hide from his enemies and can also lure his enemies into an ambush, additional information on hiding positions P_{hidden} in the virtual world of the computer game, where the agent can seek shelter with respect to the position P_{enemy} of his enemy, is needed. There is a nearly infinite number of these pairs (P_{hidden}, P_{enemy}). The algorithm presented here reduces the number of pairs to an acceptable number by utilizing specific characteristics of the geometry.

To this end, a navigation graph for the orientation of an agent in a virtual landscape is generated. Here, every traversable convex polygon of a geometric representation of the virtual landscape forms a node of the navigation graph. Furthermore, neighborhood relations of neighboring traversable, convex polygons form edges of the navigation graph. At least one node of the navigation graph is supplemented by at least one strategic item of information. The strategic information comprises details regarding visibility and/or non-visibility of the node with respect to other nodes and/or neighborhood relations with at least one neighboring node, as far as the at least one neighboring node has prespecified characteristics with respect to visibility and/or non-visibility of the at least one neighboring node with respect to other nodes.

By way of example, a sniper position in a computer game is distinguished, for example, by virtue of the fact that an agent can see many other nodes of the navigation graph from this position and therefore has himself a high visibility. At the same time, the sniper position is in the direct vicinity of a node which can be used as cover, i.e. of a node which is visible to only a few nodes.

The additional strategic information directly permit an agent to orientate himself intelligently in the virtual world using the navigation graph.

Ascertaining bottlenecks in the virtual world or the navigation graph is particularly important, because they have a decisive impact on the definition of strategic positions and information.

Bottlenecks are ascertained as follows: first a contiguous polygon which is not convex is selected. Then, edges between non-neighboring corners of the polygon, which extend completely within the polygon, are ascertained. The smallest of these edges is sought. The polygon is decomposed into two smaller polygons along said edge. The inserted edge is defined as a bottleneck as long as its length is less than a prespecified minimum length. This appears to be sensible because at such a location of the polygon, the two opposing edges are particularly close to one another.

Bottlenecks permit, for example in the simulation of rescue and evacuation actions for buildings, for example events involving fire, the rapid analysis of escape routes and scenarios in which the bottlenecks point out danger spots where the escape routes may become blocked.

In order for the navigation graph to be prepared optimally for the inclusion of strategic information, it is preferably generated as follows: a geometric representation of the virtual landscape in the form of triangular decomposition of the landscape is made available. The triangles are filtered according to the aspect of traversability by the agent. The traversable triangles are projected onto at least one projection plane. The triangles, which are distributed on the at least one projection plane, are combined for each projection plane separately to form contiguous polygons. The contiguous polygons thus obtained are decomposed into convex polygons. For each projection plane, each convex polygon forms a node of the navigation graph for said projection plane. The neighborhood relations of neighboring convex polygons form the edges of the navigation graph. The various navigation graphs of the at least one projection plane are combined to form one common navigation graph by searching for neighboring convex polygons in different navigation graphs, from which neighborhood relations and, from this, edges of the common navigation graph are generated.

It is particularly quick and precise if the usual depth information of a graphics card is used to calculate the visibility or non-visibility of a node. To this end, the visibility from the node's perspective is calculated using the graphics card. The graphics card also calculates for each pixel of the image the associated depth information. The latter can be utilized in the calculation of the volume which is visible from the node or of the visible area.

The calculation of the visibility or non-visibility permits a series of strategic classifications.

By way of example, a node can be labeled “cover” if it is visible from less than a prespecified number of nodes, that is to say from only a few nodes. If one takes cover, one is unlikely to be shot at.

In the same way it is possible for a node to be characterized as “defense position” or “sniper position” if it is visible at least to a prespecified number of nodes and has at least one neighboring node which is visible at most to a second, smaller prespecified number of nodes. In other words: the volume which is visible to the sniper is maximized and there is cover in the direct neighborhood. This gives the sniper sufficient visibility for shooting, but is at least partially covered so that he cannot easily be hit.

There is an “ambush” if one node corresponds to a “defense position” and is visible from a bottleneck or a bottleneck can be seen from the “ambush” position. An enemy must pass the bottleneck; the agent can shoot at the bottleneck from the “ambush” position and has himself a safe defense position.

The object is further achieved by a computer program which, when it is run on a computing unit, a microcontroller, DSP, FPGA or computer or on a plurality thereof in a network, carries out the inventive method in one of its embodiments.

The object is furthermore achieved by a computer program with program code means for carrying out the inventive method in one of its embodiments if the program is executed on a computing unit, a microcontroller, DSP, FPGA or computer or on a plurality thereof in a network. The program code means can, in particular, be instructions stored on a computer-readable data carrier.

The object is also achieved by a data carrier on which a data structure is stored which, when it is loaded into a working and/or main memory of a computing unit, a microcontroller, DSP, FPGA or computer or a plurality thereof in a network, can execute the inventive method in one of its embodiments.

The object is also achieved by a computer program product with program code means, stored on a machine-readable carrier, for carrying out the inventive method in one of its embodiments if the program is executed on a computing unit, a microcontroller, DSP, FPGA or computer or on a plurality thereof in a network. Here, the computer program product is understood to mean the program as a commercial product. It can in principle exist in any desired form, for example on paper or a computer-readable data carrier and can, in particular, be distributed via a data transmission network.

Finally, the object is achieved by a modulated data signal which contains instructions which can be executed by a computing unit, a microcontroller, DSP, FPGA or computer or a plurality thereof in a network for carrying out the inventive method in one of its embodiments.

A computer system suitable for carrying out the method is a stand-alone computer or microcontroller, DSPs or FPGAs as well as a network of microcontrollers, DSPs, FPGAs or computers, for example an internal, closed network, or also computers which are interconnected via the Internet. The computer system can also be realized by a client/server constellation, wherein parts of the invention run on the server, others on a client.

Further details and features can be gathered from the following description of preferred exemplary embodiments in connection with the subclaims. Here, the respective features can be implemented by themselves or together in a combination of a plurality thereof. The ways in which the object can be achieved are not limited to the exemplary embodiments.

The exemplary embodiments are illustrated schematically in the figures. Identical reference numerals in the individual figures denote here elements which are identical or functionally identical or correspond to one another in terms of their functions. Specifically,

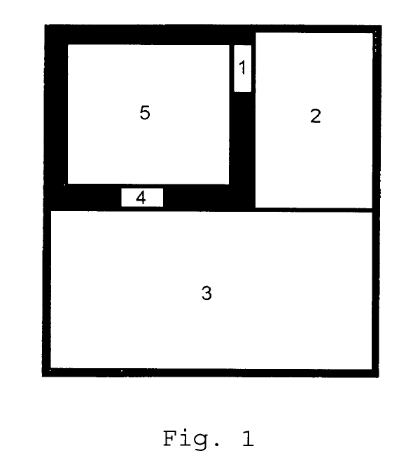

FIG. 1 shows a schematic illustration of an example of a navigation mesh;

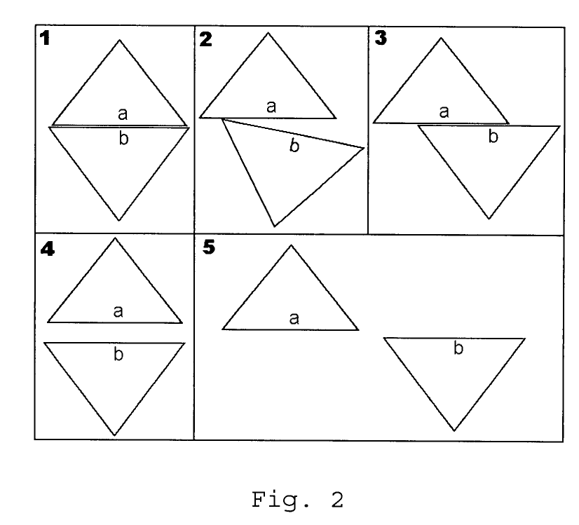

FIG. 2 shows a schematic illustration of various neighborhood relations between two triangles;

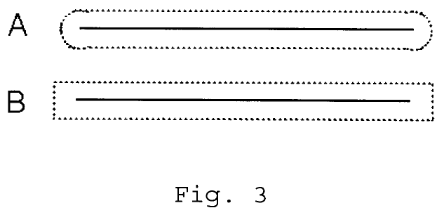

FIG. 3 shows a schematic illustration of the distance from an edge;

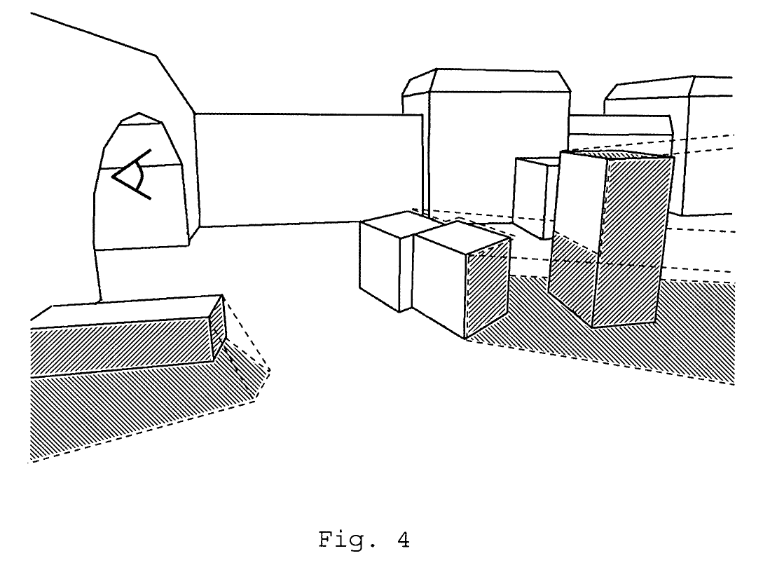

FIG. 4 shows a schematic illustration of a shadow area in three dimensions; and

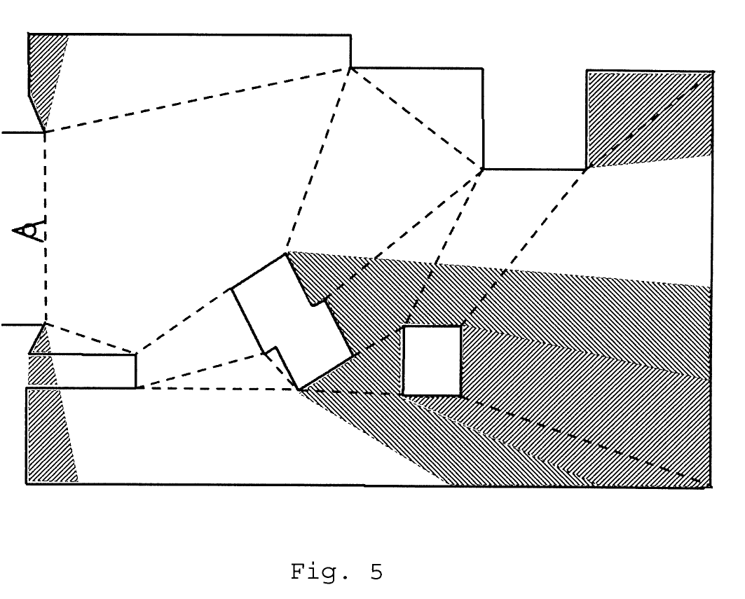

FIG. 5 shows an illustration of the scene according to FIG. 4 in a two-dimensional top view.

### 1 NAVIGATION GRAPH—OVERVIEW

There are several possibilities for implementing a navigation graph. As basic data structure the so-called NavMesh is used, whose structure is explained in detail in [Rab02]. The explanation of the structure of the NavMesh from [Rab02] is hereby incorporated in the description of the invention by reference.

[Rab02] explains exactly how a NavMesh is built, but not how it can be built from any arbitrary triangular geometry.

As the name NavMesh suggests, the NavMesh is based on the triangular geometry of the virtual environment. The NavMesh is, abstractly viewed, an outline of the traversable surfaces of a virtual world. For the structure of the NavMesh, the triangles of the geometric representation of the virtual landscape are combined to form convex polygons. These then form a new division of the virtual landscape. The data structure Gₙₐᵥₘₑₛₕ of a NavMesh is a graph. A node v of the graph Gₙₐᵥₘₑₛₕ is used to store the convex polygons. Other mathematical objects with a convex basic shape can also be associated with a node.

Within convex polygons of the geometric representation of the virtual landscape it is possible, according to the definition of “convex”, to always connect two points by a straight line, without the latter intersecting the boundary. This characteristic is suitable for a coverage area of a node in the navigation graph because it is possible to move within this area without encountering an obstacle. Correspondingly, no further edges or nodes are needed for this area, which means this represents an obstacle-free spatial division for a node of the navigation graph.

In a NavMesh, convex polygons are used because they can be built from the existing geometries. In FIG. 1, the five spatial units correspond to the five nodes of the navigation graph for this exemplary world. Each node still needs a unique position within this world in order that a pathfinding process can be started on this navigation graph. The position should additionally lie inside the associated convex polygon. The center of the convex polygon associated to the node v is used as position p for said node. The center of a convex polygon can be ascertained as arithmetic mean of all the corner points of the polygon.

An edge e=(v1, v2) is inserted between two nodes v1, v2 if it is possible to pass into the convex area of node v2 from the convex surface area of node v1. These edges only connect nodes whose convex areas are direct neighbors. This avoids that the graph obtains square complexity by each node being able to be connected to any other node.

The navigation graph must provide a function ƒ_{tograph} which enables the agent to project his position into the navigation graph inside the virtual world. In concrete terms this means that the agent, for a position A, for example his starting point, in the world, performs a function which returns to him a unique node inside the navigation graph. The same must be performable for position B, the destination. Subsequently, the agent can carry out a pathfinding process inside the navigation graph.

In order to use the result of the pathfinding process, the navigation graph likewise requires a function ƒ_{toworld} which calculates the inverse direction, i.e. calculates positions in the virtual world for nodes and edges inside the navigation graph, in order that the agent cannot just move on the navigation graph, but also in the virtual world.

### 2 NAVIGATION GRAPH—GENERATION

The navigation graph uses, as basic data structure, a NavMesh. A NavMesh can be built in various ways. The simplest possibility is for a user to create the NavMesh manually. Another possibility is to derive the NavMesh from already existing meshes of the game environment. A mesh is a contiguous arrangement of triangles, wherein neighboring triangles have two common corner points. For each corner point, it is possible to generate a list of triangles which use said corner point. In most of the games available, there are no meshes from which a NavMesh can be derived. In that case, a mesh is generated manually.

Introduced below is an algorithm which obtains only a set of triangles as input data. They do not have to be in the form of a mesh. Nevertheless, the triangles, in their entirety, need to model a sensible game world. Therefore, triangles should not intersect. Most design tools for game worlds ensure this, however, since otherwise intersecting triangles would also be represented incorrectly by a graphics card.

The main aspect of this algorithm is the manner in which the convex polygons of the NavMesh are generated. There is a nearly infinite number of different NavMesh decompositions for a virtual landscape represented by triangles. The NavMesh decomposition will be selected such that additional strategic information can be read from the resulting NavMesh.

Another goal is to keep the number of newly introduced convex polygons at a minimum. This is necessary for the use in games, since the latter always suffer from a lack of memory.

The algorithm introduced for automatic generation of a NavMesh thus has the following goals:
the input data are merely triangles which model a virtual landscape;
NavMesh generation using a minimum number of convex polygons;
the decomposition of the polygons is selected such that a strategic partitioning of the NavMesh is possible.

### 2.1 Filtering of the Input Data

The first step of the algorithm is to filter the triangles passed on to it according to the aspect of traversability. A NavMesh should only consist of areas of the game world of the kind which can be traversed by an agent (computer-controlled player). For example, triangles which are used to model a wall are undesired in the input data.

It is an option here to only pass on those triangles which count as traversable in the virtual world. This is necessary for virtual worlds which are not subject to logical physics, for example where characters can walk on ceilings.

The direction vector of gravity in the virtual world and a maximum angle for inclines which can be overcome are prespecified for the integrated input filter. These two items of data are used to filter triangles with respect to their surface normals from the set of input data. If a triangle has too great an incline, it is discarded by the filter. All those triangles on which an agent can navigate remain. These contain no more walls.

2.2 Splitting up the Set of Triangles onto Different Planes

For generating the navigation mesh, the existing geometry shall be decomposed into convex polygons. Polygons are, however, only defined in two dimensions, while the input data consist of triangles which have corner points in three dimensions. Using 3D to 2D projection, the third dimension is eliminated. Now, if all triangles from the filtered input data are projected onto a single plane which, as normal vector, already has the direction of the already known gravity, overlaps of triangles occur. This can be understood clearly if one imagines two floors, one lying above the other. If the triangles of both floors are projected onto one plane, the triangles overlap on the projection plane. The set of the resulting triangles can no longer be used.

Since the input data are not necessarily filtered (this was an optional step), it may be that some triangles are degenerated by the projection onto the plane. This means that all points of the triangle lie on one line.

In order to counter these problems, a plurality of projection planes, rather than just one projection direction, are used in the projection.

So, the triangles must be distributed on different projection planes before they can be projected. A triangle is assigned to a projection plane if the normal of the triangle differs only by a prespecified angle from the normal of the projection plane. Also, the distance of the corner points of the triangle from the projection plane must not exceed a maximum value dₘₐₓ which is defined by the designer. This maximum value depends on the virtual landscape and should be selected such that no triangles overlap after the projection. However, this value can easily be defined by the designer. It can be the height of a step, for example.

One possibility of approaching these problems is to successively add new projection planes if a triangle cannot be added to any existing projection plane.

### 2.3 Generating Maximum Contiguous Polygons

The step of generating maximum contiguous polygons arises from the condition that the NavMesh algorithm should generate a minimum number of convex polygons. It is also desirable to control the generation of the convex polygons such that strategic information can be read from the NavMesh. This requires that navigation bottlenecks in the virtual world are being recognized.

At this point, many NavMesh algorithms which operate on the basis of already existing meshes use an algorithm by Seidel and Mehlhorn [Toz02] which combines the triangles to form convex polygons. The algorithm is very fast, having O(n) run time, where n is the number of triangles. However, there is no control over the manner in which these triangles are assembled. This also depends on the distribution of the triangles, as is already present. This means that the resulting convex polygons consist of a subset of the edges, as were already present in the triangles. That is to say, no new edges are introduced. This, however, is very critical if the aim is to recognize bottlenecks in the game geometry. This is because in the geometrical representation of the virtual world, marking of such bottlenecks by means of a triangle edge is not ensured.

In order to circumvent this problem, all the triangles are assembled to form maximal contiguous polygons in the algorithm proposed here. If a maximally contiguous polygon is already convex, it is already part of the minimum set of convex polygons and does not need to be considered further.

Therefore, only those edges remain which mark the side of a traversable surface. All other edges are removed by virtue of this step. A convex partition algorithm can be used to subsequently partition these contiguous polygons into convex polygons, which is described in more detail below.

The main object is now to combine the triangles distributed on the projection planes to form contiguous polygons, separately for each projection plane.

### 2.3.1 Neighborhood Relation Between Triangles

For each triangle it is necessary to ascertain those triangles which adjoin its side, so that triangles can be interconnected to form a contiguous polygon. Since one of the conditions for the NavMesh algorithm was the arbitrary arrangement of triangles, a special algorithm is needed, which can be used to find these neighboring triangles within an adequate period of time. This object is very quickly achieved in a mesh if a list of triangles which share a corner point are stored for each of these corner points. Then, only a search for neighbors for a triangle in the lists of the corner points of this triangle is necessary. This object is thus efficiently achieved on account of the required uniformity for a mesh.

FIG. 2 shows the example of a mesh in subimage 1. However, if an arbitrary number of triangles is viewed, there are also other cases where triangles are neighbors, e.g. in subimages 2 and 3. There are furthermore the subimages 4 and 5 which show cases where the triangles are no longer neighbors.

The neighborhood test for triangles can be reduced to a local search for edges. This is done also because a later aim will be to find polygons which adjoin an already existing polygon. Each polygon (and thus also triangle) consists of edges which form the boundary of a polygon. A polygon is defined by a list of corner points. Drawing edges from corner point to corner point in the order of occurrence in the list results in a polygon if additionally the end point is connected to the starting point.

Since triangles must not overlap, it is ensured that, if two edges are parallel neighbors, the triangles are also neighbors (according to subimage 3). It must therefore be possible to find an edge of a polygon that is related to an edge of another polygon. This could be implemented by testing one edge with respect to all other edges. This, however, has a run time of O(n²), where n is the number of all the edges. In order to avoid this complexity, a spatial acceleration structure is used, in which all the edges are inserted. This spatial acceleration structure is used to ascertain the neighboring edges in constant time. The acceleration structure could be, for example, a uniform grid.

Once the edges that are located in the direct neighborhood of another edge are ascertained, it is necessary to test whether these edges represent true neighbors. In this respect, there are two criteria which need to be tested. The first criterion is the parallelism of the two edges to be compared. If these edges are not parallel (or at least nearly parallel, i.e. except for a prespecified small angle), they cannot be neighbors. This test is faster than the test of the second criterion and is therefore always performed first. The second criterion is the distance dₘₐₓ between the two edges. Here, the distance must not be regarded as a one-dimensional test, as is known for the distance between two points.

FIG. 3 shows the coverage area of an edge A. The dashed line around edge A shows the area within which all the points do not exceed a distance dₘₐₓ from the edge. If there is any point of the edges tested for neighborhood in this coverage area, the edge is rated a neighbor.

The applicant has simplified the test as shown for the edge B in FIG. 3. In the case of edge B, the distance at the corner points is somewhat expanded. This is acceptable because the distance dₘₐₓ has a very small value and thus the error to be expected will be very small at the corner points. If both criteria are met, the tested edge is declared a neighbor.

This neighborhood test can now be used to find neighboring polygons which will be merged to form a larger polygon in the next step.

### 2.3.2 Merging Neighboring Polygons

Now that it is possible to ascertain the neighbors of a triangle, said triangle must be merged with its neighbors. Here, care is taken that a triangle is not merged with itself. For the purpose of merging two triangles, the two triangles are joined at that edge where they are in contact. To this end, that edge where they are in contact is in each case removed in both triangles, and the two triangles are connected to one another by two new edges which replace those parts of the edge, which was removed, where they were not identical or did not protrude.

This method is performed iteratively in the same manner with the resulting polygons.

There may, of course, be more locations where two polygons are in contact, but once the two polygons have merged to form one polygon, a repair algorithm is used which removes those edges.

Merging may result in different constellations in which it is necessary to prepare the new polygon. The first case is that case in which, on account of the connection of the two polygons with the two new edges, the very same have the length zero because the two edges which were removed were lying exactly one on top of the other. The repair algorithm now runs proceeding from the joint over the polygon and removes edges whose lengths are less than a defined minimal length. This also removes edges of the length zero which can cause problems in the neighborhood calculation because they have no direction.

The second case in which the newly resulting polygon needs to be prepared occurs if merging leads to peaks in the polygon boundary. These are distinguished by the fact that the angle between two edges in a node is 0 degrees. This peak is removed by deleting exactly this node from the list of polygons. An iteration over the polygon is likewise performed to this end, and the individual nodes are checked for such an occurrence.

The third and last case is more of a cosmetic measure. Merging may lead to polygons in which the angle between two edges in a node is exactly 180 degrees. This appears as if there is no node point at this location, since the incoming and outgoing edge lie on one line. These nodes are likewise removed from the list of polygons.

Since all three cases require iteration over the polygon as soon as something has changed, these algorithms are executed only when they are really necessary. For this purpose, case one is carried out after each merging, but only locally around the location at which the two polygons were connected to one another. This is necessary since edges which influence the neighborhood search can occur at this location. The other two cases are not relevant to the correct neighborhood search and are therefore postponed until all possible polygons have been connected to one another.

This merging algorithm is used to generate the maximally contiguous polygons.

### 2.3.3 Algorithm for Generating Contiguous Polygons

The algorithm for generating the contiguous polygons proceeds with the set of triangles which are assigned to a plane. These are renamed polygons and entered in a global list of polygons which is to contain the contiguous polygons once the algorithm has run through. Afterwards, all triangles are inserted into the acceleration structure for the neighborhood search. Subsequently, iteration is performed over the set of these polygons and each polygon is extended by merging neighboring polygons as far as possible. To this end, the polygon currently processed is in each case completely removed from the acceleration structure, so as to avoid that edges of the same polygon are found as neighbors. Once a polygon is merged with the polygon which is currently to be completed, it is likewise removed from the acceleration structure and from the list of global polygons. Once iteration over all the polygons in the global list has been carried out and the latter has been maximally extended, said list then only contains the contiguous polygons which were searched for.

### 2.4 Generation of Convex Polygons

Now that a set of contiguous polygons has been obtained, these must be partitioned into convex polygons. For this purpose, each contiguous polygon is partitioned into convex polygons separately. This is achieved by a convex partition algorithm [Gre83]. Here, an exact algorithm which, accelerated by dynamic programming, pursues a minimization goal is used in a deliberate fashion. As standard, this algorithm attempts to minimize the number of convex polygons.

On inspection of the resulting convex polygons, the conclusion is very quickly drawn that this result is unsatisfactory since convex polygons do not observe spatial boundaries. However, it is one of the global goals of the NavMesh generation that the NavMesh is built with respect to strategic information. This strategic information heavily depends on bottlenecks in the navigation surface. Since the bottlenecks also apply to human players, it is advantageous if the bottlenecks are recognized. At a bottleneck, a player cannot evade an attack. Also, bottlenecks are usually doors or corridors.

Bottlenecks are ascertained as follows: first, a contiguous polygon which is not convex is selected. Then, edges between non-neighboring corners of the polygon are ascertained which extend completely inside the polygon. What is sought is the smallest of these edges. Along said edge, the polygon is divided into two smaller polygons.

The inserted edge is defined as bottleneck as long as its length is less than a prespecified minimum length. This seems sensible since at such a location of the polygon, the two opposing sides are particularly close to one another.

The process of partitioning contiguous polygons is continued until the contiguous polygon is divided completely into convex polygons.

The convex partition algorithm is used to introduce new edges in contiguous polygons. The criterion for the selection of the new edges was chosen such that new edges are inserted exactly at bottlenecks of the contiguous polygon.

Once the convex partition algorithm has calculated the optimum partitioning, first the convex polygons are read from the data structures of this algorithm. The neighborhood relation is also stored there. It is easy to gather which convex polygons are neighbors. This information is likewise gathered from the algorithm and is used for the NavMesh data structure to be built as edge which indicates which nodes (convex areas) are interconnected. Additionally, all edges which do not yet have a neighbor are marked. A search for the neighbors of these edges is carried out in the following step because the search for these neighbors must be carried out beyond the boundaries of a contiguous polygon.

### 2.5 Building the NavMesh Graph

Only a partitioning of the virtual landscape into optimum convex polygons has taken place so far. Now the convex polygons which are in part discontiguous must be combined in the form of a graph.

Graph edges were already inserted between convex polygons during the generation of the convex polygons if these were located within the same contiguous polygon. Now the connections between convex polygons comprising different contiguous polygons must be established. In each convex polygon, those polygon edges which do not yet have neighbors have already been marked.

The convex polygons are transformed into the 3D space of the virtual world so that the neighbors which are located on different projection planes can be found. To this end, all corner points of the polygon are calculated back into the 3D space using the function ƒ_{toworld}. This means that the polygons will remain polygons, since they are produced from a 2D representation. Subsequently, an algorithm is used which is similar to that of the neighborhood search during the production of the contiguous polygons in 2D, which can be used to find a neighbor edge that is related to a polygon edge.

To this end, a spatial acceleration structure is used again, but this time for the three-dimensional virtual space. In order to find neighbor edges, first all polygon edges in the surrounding area of a polygon edge, which are not part of the polygon that is currently being examined, are ascertained. The criteria for a neighbor edge are identical to the criteria seen in the neighborhood search in section 2.3.1. This time, however, the distance value dₘₐₓ is a great deal higher since another aim is to find polygon edges of convex polygons which form a stairway or the like. The criterion for parallelism remains unchanged.

Once such a neighbor edge is ascertained it is clear that these two convex polygons must be connected by virtue of a graph edge.

However, it is often the case that these two polygon edges are not of the same length. The longer polygon edge is therefore split such that a polygon edge results which is exactly as long as the shorter polygon edge, and lies exactly opposite the latter. All newly resulting polygon edges must again be integrated in the 3D acceleration structure, since other polygons may adjoin these polygon edges.

The process of neighbor search is repeated until all the polygon edges have been examined for a neighborhood relation once. Once the step is finished, a complete NavMesh has been generated.

### 3. STRATEGY ANALYSIS

The strategy analysis is based on the NavMesh which was previously generated using the algorithm. Here, two different types of strategic information are gained. Firstly, ambush positions and, secondly, sniper positions are obtained. Sniper positions are good tactical positions if one is in possession of a long range rifle.

### 3.1 Sniper Position

Finding sniper positions is a fully automatic process. Used for this purpose is an algorithm from the book “AI Game Programming” [Rab02] in modified form. This algorithm rates a position as sniper position if many nodes can be seen in the navigation graph from this position and there is a direct neighbor node from which only few nodes can be seen.

This decision criterion does not work with a NavMesh whose convex areas are trimmed to maximum size, as in the case of the present NavMesh, and therefore cover very different areas or volumes. Therefore, the decision criterion is not connected to the number of visible nodes, but the amount of visible volume. To this end, the graphics card is used to render a panoramic view for a position. Subsequently, the depth value of each pixel is taken (z buffer) and a pixel is interpreted as a cone. Using the assumption of cones and the depth of the space in this pixel, the entire visible volume can be calculated if all pixel volumes are added up. Then, a search is carried out for nodes in which much spatial volume is seen but which have a neighbor node in the NavMesh where only very little spatial volume is seen and which thus offers possible cover.

### 3.2 Ambush Positions

Finding the ambush position requires a classification of the convex polygons of the NavMesh into rooms and corridors. This classification can be carried out manually or by a machine. Once the information is obtained it is possible to say where in the geometry doors are. These are the transitions from rooms to corridors and vice versa. The NavMesh introduced in this application enables such a selection in the first place, since polygon edges were introduced at exactly these bottlenecks, the doors.

Once the doors to a room have been ascertained, a plurality of images covering the entire viewing angle of the door are rendered by the graphics card from the center points of the doors. Of these images, as was already the case with the sniper positions, only the depth value of the individual pixels is used. The depth values are used to calculate the volume which lies in that area of the images which cannot be seen from the door. This area is referred to below as the shadow area of the viewer (eye symbol). FIG. 4 shows such a shadow area, illustrated by the hatched surfaces and the dashed lines visualizing the volume of this area.

If an individual pixel of the rendered image is viewed from the viewer angle of the center point of the door, the shadow area is that volume which starts with the depth value of the pixel and extends to a defined maximum. This volume has, for each pixel, the form of a frustum. This frustum is calculated for each pixel of the image.

If a game character is completely located in a shadow volume, it has taken cover there. Now the problem arises that an individual frustum does not suffice for encompassing a complete game character at the narrower end of the frustum. It is therefore necessary to ascertain which of the elemental shadow areas in connection with their neighbor volumes offer sufficient shadow volume for a game character to be encompassed at the small end either in crouching or upstanding form.

Pixels are combined to form groups which lead to a contiguous obstacle blocking the view with respect to the rendered image from the door. These groups of pixels which can be described by a polygon are examined as to whether they are wide enough, in the horizontal direction, for covering a complete game character. Here, only the horizontal expansion is viewed, since no information on the geometry within the shadow volume, that is to say non-visible area, is available in the rendered image. Whether an obstacle blocking the view is tall enough will be discovered only at a later stage. Only the frusta resulting from the groups of pixels which were wide enough are used further in the following process, the others are discarded. FIG. 4 shows an obstacle blocking the view at the bottom left. This obstacle is not tall enough for a game character to take cover behind it. However, had there been a ditch behind this wall, the cover would, in turn, suffice.

The next step involves performing a section between the remaining frusta and the NavMesh. It is the slice planes that are of interest here. These slice planes are part of the original NavMesh, with the information that these parts of the NavMesh now lie within the shadow area of the viewer from the door now being available for these parts. This can be seen in FIG. 5. The existing NavMesh is illustrated by the dashed lines.

Those parts of the NavMesh which lie within the shadow area are illustrated by hatching. Furthermore, different types of hatching can be seen. The different types of hatching illustrate that the shadow areas offer different types of cover. One shadow area only offers cover when the game character is in crouched position and the other when the game character crouches or is upstanding. This can be seen when comparing FIG. 4 to FIG. 5, with FIG. 5 illustrating a two-dimensional top view of the scene according to FIG. 4.

The resulting slice plane, however, cannot be used in its entirety. Every elemental slice plane, the slice plane between NavMesh and frustum, is now examined as to whether the shadow area above it is high enough for a crouching or upstanding game character to take cover. This test is a vertical supplementation to the already performed horizontal cover test using the groups of pixels. If a slice plane, and the shadow volume above it, offer neither sufficient cover to a crouching nor an upstanding game character, it is discarded.

The remaining slice planes are now used to carry out repartitioning of the NavMesh, with the convex polygons of the NavMesh being changed such that they either contain only shadow areas or no shadow areas. To this end, the techniques described further above, such as creating maximally contiguous polygons and convex polygons, are used. The result is a new NavMesh which, in turn, contains only convex polygons which, however, have different shadow area classifications.

The entire process is repeated for all doors. Further partitioning of shadow areas of other doors may also be possible here, which, however, does not hinder the functionality of the algorithm. As a matter of fact, it is desired. The result is, subsequently, shadow areas which offer cover to a virtual character with respect to a plurality of doors in one room.

The information obtained are stored in the NavMesh and used by the agents during the running time when these look for cover with respect to doors in order to lure an enemy into an ambush.

### LIST OF CITED LITERATURE

[Gre83] Daniel H. Greene. “The decomposition of polygons into convex parts”. In Franco P. Preparata, editor, Computational Geometry, volume 1 of Adv. Comput. Res., pages 235-259. JAI Press, Greenwich, Conn., 1983.
[Rab02] Steve Rabin (Ed.): “AI Game Programming Wisdom”, Charles River Media, Hingham, Mass., 2002.
[Toz02] Paul Tozour: “Building a Near-Optimal Navigation Mesh”. In [Rab02]

1. A method for generating a navigation graph for the orientation of an agent in a virtual landscape, comprising the following steps:
a) each traversable, convex polygon of a geometric representation of the virtual landscape forms a node of the navigation graph;
b) neighborhood relations of neighboring traversable, convex polygons form edges of the navigation graph;
c) at least one node of the navigation graph is supplemented by at least one item of strategic information;
d) wherein the strategic information comprises details regarding visibility and/or non-visibility of the node with respect to other nodes and/or neighborhood relations with at least one neighboring node, as far as the at least one neighboring node has prespecified characteristics with respect to visibility and/or non-visibility of the at least one neighboring node with respect to other nodes;
e) a contiguous polygon is selected which is not convex;
f) edges between non-neighboring corners of the contiguous polygon are ascertained which extend completely inside the contiguous polygon;
g) the smallest of these edges is sought;
h) along this edge, the contiguous polygon is decomposed into two smaller polygons; and
i) the inserted edge is defined as bottleneck as long as its length is less than a prespecified minimum length.

2. The method as claimed in claim 1 wherein:
a) a geometric representation of the virtual landscape in the form of triangular decomposition of the landscape is made available;
b) the triangles are filtered according to the aspect of traversability by the agent;
c) the traversable triangles are projected onto at least one projection plane;
d) the triangles, which are distributed on the at least one projection plane, are combined for each projection plane separately to form contiguous polygons;
e) the contiguous polygons thus obtained are decomposed into convex polygons;
f) for each projection plane, each convex polygon forms a node of the navigation graph for said projection plane;
g) the neighborhood relations of neighboring convex polygons form the edges of the navigation graph; and
h) the various navigation graphs of the at least one projection plane are combined to form one common navigation graph by searching for neighboring convex polygons in different navigation graphs, from which neighborhood relations and, from this, edges of the common navigation graph are generated.

3. The method as claimed in claim 1 wherein:
the visibility or non-visibility of a node is calculated using depth information which is calculated and made available by a graphics card.

4. A navigation graph for the orientation of an agent in a virtual three-dimensional landscape, with the following characteristics:
a) each traversable, convex polygon of a geometric representation of the virtual landscape forms a node of the navigation graph;
b) neighborhood relations of neighboring traversable, convex polygons form edges of the navigation graph;
c) at least one node of the navigation graph is supplemented by at least one item of strategic information;
d) wherein the strategic information comprises details regarding visibility and/or non-visibility of the node with respect to other nodes and/or neighborhood relations with at least one neighboring node, as far as the at least one neighboring node has prespecified characteristics with respect to visibility and/or non-visibility of the at least one neighboring node with respect to other nodes; and
e) the navigation graph has at least one bottleneck which is ascertained as follows:
f) a contiguous polygon is selected which is not convex;
g) edges between non-neighboring corners of the contiguous polygon are ascertained which extend completely inside the contiguous polygon;
h) the smallest of these edges is sought;
i) along this edge, the contiguous polygon is decomposed into two smaller polygons; and
j) the inserted edge is defined as bottleneck as long as its length is less than a prespecified minimum length.

5. A computer program, which, when it is run on a computing unit, a microcontroller, DSP, FPGA or computer or on a plurality thereof in a network, carries out the method as claimed in claim 1.

6. A computer program with program-code means as claimed in claim 5, which are stored on a computer-readable data carrier.

7. A computer program product with program-code means stored on a machine-readable carrier for executing all the steps as claimed in claim 1 if the program is executed on a computing unit, a microcontroller, DSP, FPGA or computer or on a plurality thereof in a network.

8. A modulated data signal which contains instructions, which can be executed by a computing unit, a microcontroller, DSP, FPGA or computer or a plurality thereof in a network for carrying out the method as claimed in claim 1.

9. A computer system or computer network with at least one device which is configured to carry out the method as claimed in claim 1.

10. The method as claimed in claim 2 wherein:
the visibility or non-visibility of a node is calculated using depth information which is calculated and made available by a graphics card.

11. A computer program product with program-code means stored on a machine-readable carrier for executing all the steps as claimed in claim 2 if the program is executed on a computing unit, a microcontroller, DSP, FPGA or computer or on a plurality thereof in a network.

12. A computer program product with program-code means stored on a machine-readable carrier for executing all the steps as claimed in claim 3 if the program is executed on a computing unit, a microcontroller, DSP, FPGA or computer or on a plurality thereof in a network.

13. A modulated data signal which contains instructions, which can be executed by a computing unit, a microcontroller, DSP, FPGA or computer or a plurality thereof in a network for carrying out the method as claimed in claim 2.

14. A modulated data signal which contains instructions, which can be executed by a computing unit, a microcontroller, DSP, FPGA or computer or a plurality thereof in a network for carrying out the method as claimed in claim 3.

15. A computer system or computer network with at least one device which is configured to carry out the method as claimed in claim 2.

16. A computer system or computer network with at least one device which is configured to carry out the method as claimed in claim 3.
